(19) United States
(12) Patent Application Publication
(10) Pub. No.: US 2009/0012903 A1
(43) Pub. Date: Jan. 8, 2009

(54) ONLINE EXCHANGE FOR INTERNET AD MEDIA

(75) Inventors: Anand Subramanian, New York, NY (US); Shanthi Sarkar, New York, NY (US)

Correspondence Address: DARBY & DARBY P.C., P.O. BOX 770, Church Street Station, New York, NY, 10008-0770, US

(73) Assignee: ContextWeb, Inc., New York, NY (US)

(21) Appl. No.: 11/933,187

(22) Filed: Oct. 31, 2007

Related U.S. Application Data
(63) Continuation-in-part of application No. 11/627,901, filed on Jan. 26, 2007.
(60) Provisional application No. 60/762,980, filed on Jan. 26, 2006.

(51) Int. Cl. G06Q 30/00

(52) U.S. Cl. 705/80

(57) ABSTRACT

Presented are embodiments of methods and systems that create an open ad exchange for online advertising by creating and running a premium ad exchange to provide pricing control to both publishers and advertisers. Techniques are presented where advertisement campaigns are matched with ad spot for sale on relevant pages based on a bid-ask price scheme. Further, techniques are presented for allowing publishers of advertisements to still realize revenue when the exchange cannot sell an impression at an asking price by sending that impression to a backup tag.

### CLAIM OF PRIORITY

This application is a continuation-in-part of U.S. patent application Ser. No. 11/627,902, which was filed on Jan. 26, 2007 and claims the benefit of priority, under 35 U.S.C. § 119(e), of U.S. Provisional Application No. 60/762,980, filed Jan. 26, 2006, each of which is hereby incorporated by reference in its entirety.

### FIELD OF INVENTION

The present invention relates to a new self-service portal that enables publishers to name their own CPM (Cost Per Thousand) AskPrice™ and advertisers to target campaigns to content categories that match their desired audience's interests. Further, techniques are presented for allowing publishers of advertisements to still realize revenue when the exchange cannot sell an impression at an AskPrice™ by sending that impression to a backup tag.

### BACKGROUND OF THE INVENTION

Standard producers of online ad-request inventory are publishers. They own or operate web sites that users visit using web browsers, and they allocate space on those pages where advertisements may be added. Consumers of online ad-request inventory are Advertisers. They offer products or services online, and they create advertisements for those offerings which they desire to show to Internet users. Those advertisements are then added into the publishers' pages so that users see them as they browse. Each time an individual user browses to a publishers' page that contains pre-allocated space for advertising, an Ad Request to deliver an ad to fill that allocated space can be made to an Ad Server either by the user's browser or by the Publisher.

Publishers are able to predict in advance approximately how many times in a given day or month a user will browse (or request to view) one of the pages on their site. By combining this prediction with the knowledge of which page spaces have been set aside for advertisements, Publishers can estimate how many advertisements will be shown to users visiting their site in a given period of time. Because Publishers are paid for allowing parts of their pages to be filled with advertisements, this estimate of future ads to be shown may be considered an asset owned by that Publisher. As with any other asset, this asset can be sold to advertisers or their agents. The asset can be called an Ad Request Inventory or Ad Media. Advertisers and/or their agents who buy this inventory may be called media buyers. Publishers and/or their agents who sell this inventory may be called media sellers.

When the Ad Media is considered in terms of the number of expected ad requests, the inventory is typically quantified as a particular number of Ad Impressions. Ad Impressions are priced as a Cost-Per-Thousand Impressions (“CPM”). Additionally, because a click may or may not result each time an ad is shown to a user, inventory may also be quantified as a particular number of expected Ad Clicks, and could be priced as a Cost-Per-Click (“CPC”).

Prior to buying ad media, media buyers place their advertisements into a specialized system called an Ad Server. An Ad Server selectively delivers one or more of the ads placed by the media buyer in response to requests made to the Ad Server. The Ad Server provides the Media Buyer with a small piece of industry-standard software called an Ad Tag. Upon its execution, the Ad Tag sends a request to the ad server to deliver one or more of the media buyer's ads.

When media buyers buy ad media they often provide the same Ad Tag, or a slightly modified version, to the media seller. The media seller assures that the Ad Tag is executed according to the contracted terms of the sale, i.e., locations, quantity, and other parameters. Among these contracted terms is a categorization of the pages where the ads are to be shown. Categorization allows media buyers to buy media across a group of Publishers on the basis of a number of impressions, or clicks, in particular category or categories. For example, a bank wishing to advertise its mortgage programs can restrict its ads to be shown only on pages categorized as Finance-related, or Home Finance-related. Targeting an ad placement in this manner allows media buyers to spend ad budgets more efficiently. Also media is not wasted showing unrelated ads.

The ability to buy and sell media by category is a feature of the current online advertising market. Categorization adds value, and makes it possible for media sellers to demand higher prices (e.g., CPM or CPC). The demand for well categorized media implies demand for scalable categorization processes. Prior art processes include both manual and automated approaches. A manual approach has human editors reviewing publishers' sites to categorize the whole site, either to a particular category, or to categorize different areas of the site to various different categories. This process can easily become labor intensive requiring a large number of human editors. This approach quickly becomes untenable on pages that contain dynamic content—e.g., online newspapers where stories might be different subjects on different days. For dynamic content, human editors cannot logistically keep up with re-reading these pages' content and changing their categorization decisions.

U.S. Published Patent Application No. 2002-0123912-A1, titled “Internet Contextual Communication System” to Subramanian et al., automates approaches for media categorization that are more scalable for both static content and dynamic content situations. However, even with effective automated categorization systems, the burden remains on media sellers to choose among the available automated and manual approaches. This choice results in the presence of a confusing mix of approaches in the advertising market. Therefore, further increasing the burden on media buyers to work with a multitude of approaches and manage quantities of inventory bought from each seller in each model. U.S. Published Patent Application No. 2002-0123912-A1 is hereby incorporated by reference in its entirety.

Another problem present in the prior art models affects the media buyers' experience in monitoring the performance of their media buys. In order to monitor the effectiveness of their media buys, media buyers receive regular reports on the number of ad impressions and/or clicks delivered each day, month, etc. However, for media buys that are not site specific, media sellers rarely if ever report which particular Publishers' sites ran the media buyer's ads. Oftentimes within a media-buy there are some Publishers' sites where the ads are effective, and some sites where the ads are ineffective. Similarly within an uncategorized or run-of-network media-buy there will often be one or more categories that are effective and one or more that are ineffective. Even within a categorized media-buy there will often be one or more sub-categories that are relatively effective, and one or more that are relatively ineffective. However, media buyers have no mechanism to determine which part of their buys are the effective parts. Additionally, even if the effective buy parts are known, media buyers can not act on that knowledge because media often cannot be bought at the next level of granularity (e.g., sub-category level or site-specific).

Missing from the art is a mechanism to create a standardized marketplace where parties can meet to buy and sell media according to free-market prices and a standard categorization approach. The present invention can satisfy one or more of these and other needs.

### BRIEF DESCRIPTION OF THE DRAWING FIGURES

For as better understanding of the nature, objects, and processes involved in this invention, reference should be made to the detailed description taken in conjunction with the accompanying drawings, in which:

FIG. 1 illustrates a client-server computer network (e.g., the Internet) constructed in accordance with an embodiment of this invention.

FIG. 2 illustrates an example processing operation to serve and track advertisements in accordance with an embodiment of this invention.

FIG. 3 illustrates an example user interface process that an advertiser executes in accordance with an embodiment of this invention.

FIG. 4 illustrates an example processing operation that an advertiser executes in accordance with an embodiment of this invention.

FIG. 5 illustrates a processing operation for an advertiser from an exchange operator's point of view in accordance with an embodiment of this invention.

FIG. 6 illustrates an example user interface process that a publisher executes in accordance with an embodiment of this invention.

FIG. 7 illustrates an example processing operation that a publisher executes in accordance with an embodiment of this invention.

FIG. 8 illustrates a processing operation for a publisher from the exchange operator's point of view in accordance with an embodiment of this invention.

FIG. 9 illustrates a processing operation for billing and accounting in accordance with an embodiment of this invention.

FIG. 10 illustrates an example system architecture which may be used in accordance with an embodiment of this invention.

FIG. 11 illustrates processing operations undertaken by advertisers, publishers, and the exchange operator in accordance with an embodiment of this invention.

FIGS. 12A-12C illustrate several advertising negotiation and payment models in accordance with an embodiment of this invention.

FIG. 13 illustrates a processing operation for a many-to-many exchange in accordance with an embodiment of this invention.

FIG. 14 illustrates the effect of dynamic pricing on impression volume and reach of an advertisement in accordance with an embodiment of this invention.

FIG. 15 illustrates another system architecture in accordance with an embodiment of this invention.

FIG. 16 illustrates a exchange website architecture in accordance with an embodiment of this invention.

FIG. 17 illustrates another website architecture specific to advertisers in accordance with an embodiment of this invention.

FIG. 18 illustrates an example advertiser home page graphical user interface in accordance with an embodiment of this invention.

FIG. 19 illustrates an example offer management web page in accordance with an embodiment of this invention.

FIG. 20 illustrates an example offer editor web page in accordance with an embodiment of this invention.

FIG. 21 illustrates an example banner management web page in accordance with an embodiment of this invention.

FIG. 22 illustrates an example banner editor web page in accordance with an embodiment of this invention.

FIG. 23 illustrates an example URL management web page in accordance with an embodiment of this invention.

FIG. 24 illustrates an offer state transition diagram in accordance with an embodiment of this invention.

FIG. 25 illustrates a contract state transition diagram in accordance with an embodiment of this invention.

FIG. 26 illustrates a physical network diagram in accordance with an embodiment of this invention.

FIG. 27 illustrates another system architecture in accordance with an embodiment of this invention.

FIG. 28 illustrates a classification system architecture in accordance with an embodiment of this invention.

FIG. 29 illustrates a pricing process in accordance with an embodiment of this invention.

FIG. 30 provides a schematic diagram depicting high-level ownership and trading dynamics that are present in an embodiment of the present invention.

FIG. 31 depicts a first portion of an embodiment of a system that is in accordance with the invention.

FIG. 32 depicts another portion of an embodiment of a system that is in accordance with the invention.

FIG. 33 illustrates a process in accordance with the embodiment of the system depicted in FIGS. 31 and 32.

FIG. 34 depicts an illustrative embodiment of a market accessor tool in accordance with the invention.

FIG. 35 depicts an illustrative report generated by an embodiment of the present invention.

FIGS. 36 and 37 illustrate two conventional approaches for delivering advertisements.

FIGS. 38 and 39 depict other portions of the process depicted in FIG. 33.

FIGS. 40 and 41 depict additional aspects of the high level ownership and trading dynamics depicted in FIG. 30.

FIG. 42 depicts another embodiment of a market accessor tool in accordance with the invention.

FIG. 43 provides a schematic diagram depicting how Advertizers bid to Publisher pages.

FIG. 44 provides a schematic diagram depicting how the Publisher requests Advertiser pages.

FIG. 45 provides a schematic diagram depicting an online Advertising marketplace as supported by the present invention.

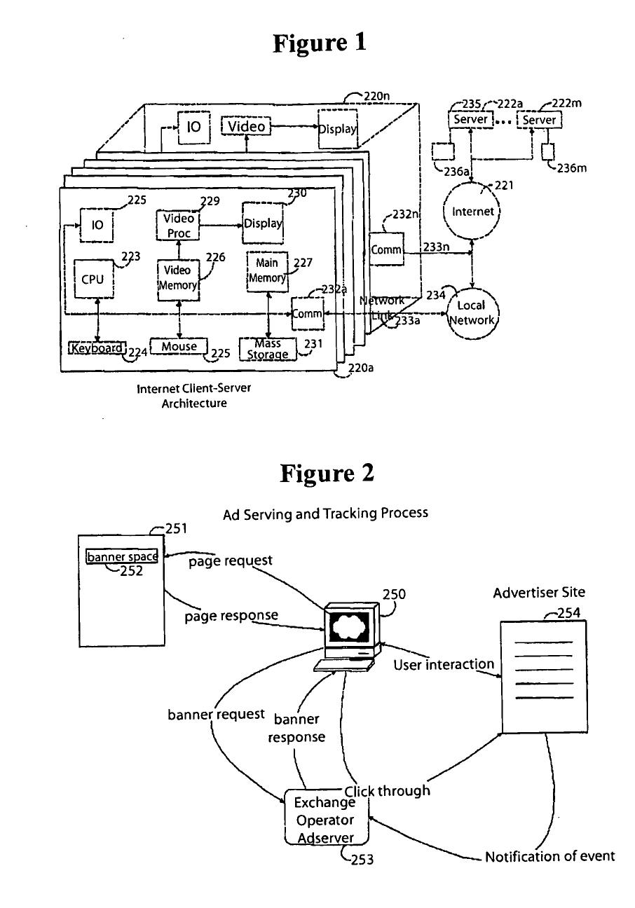

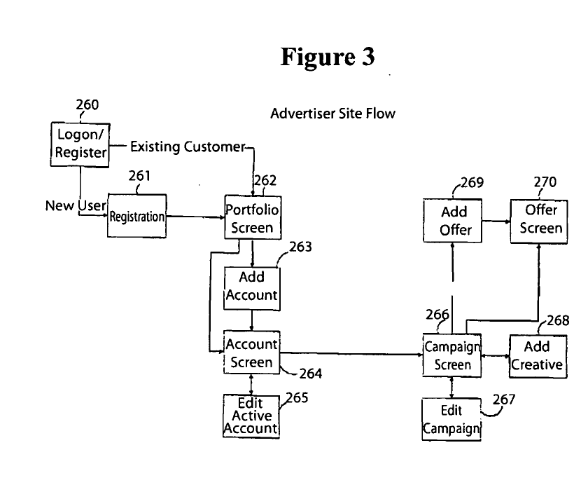

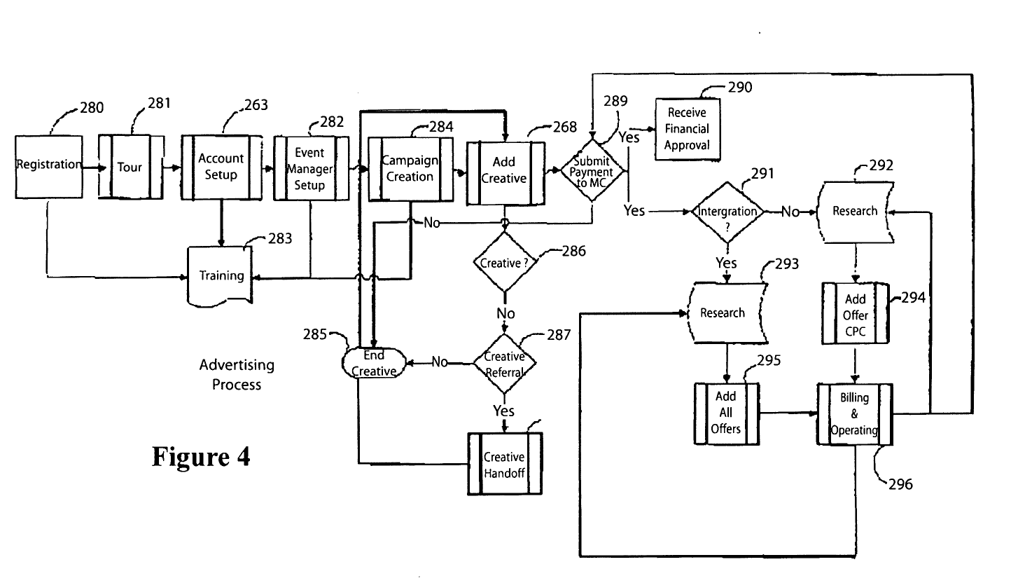

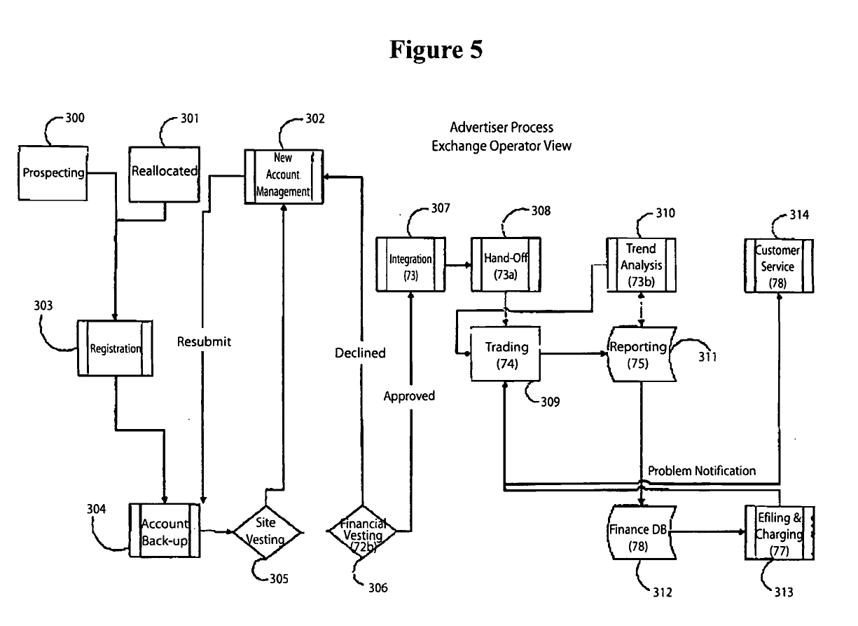

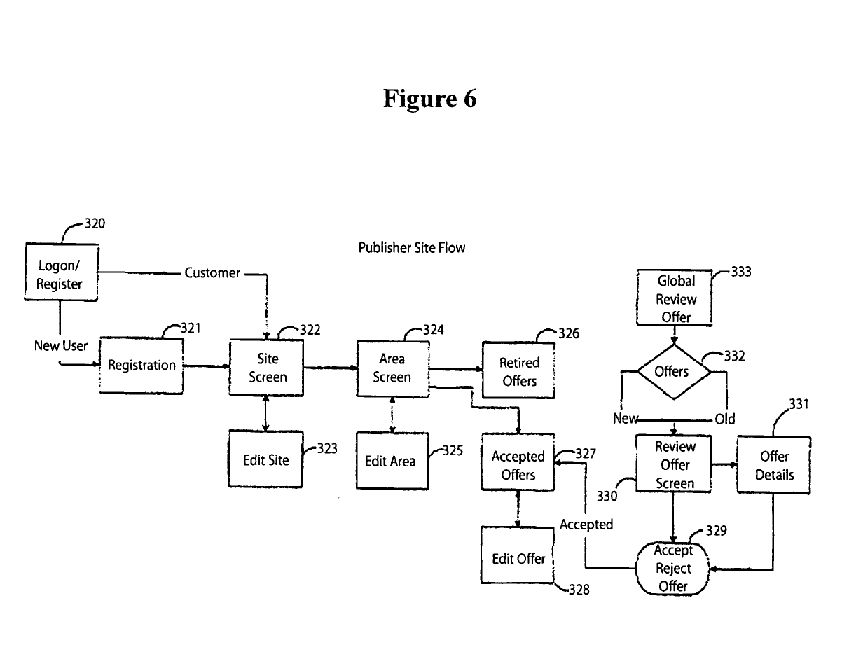

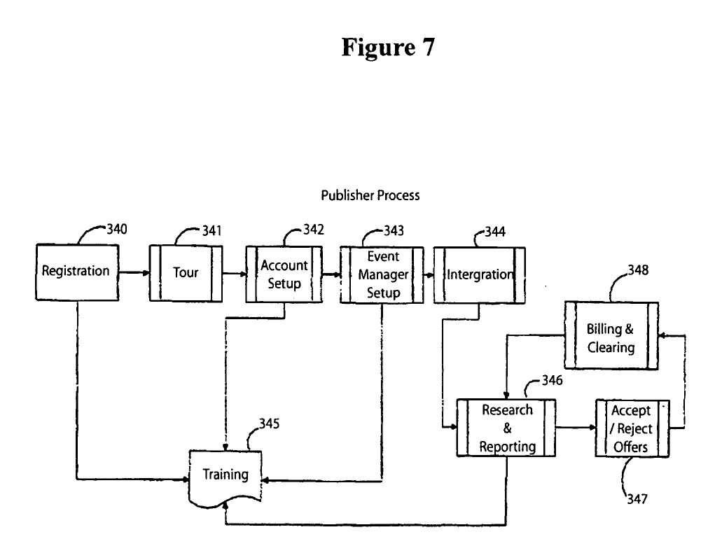

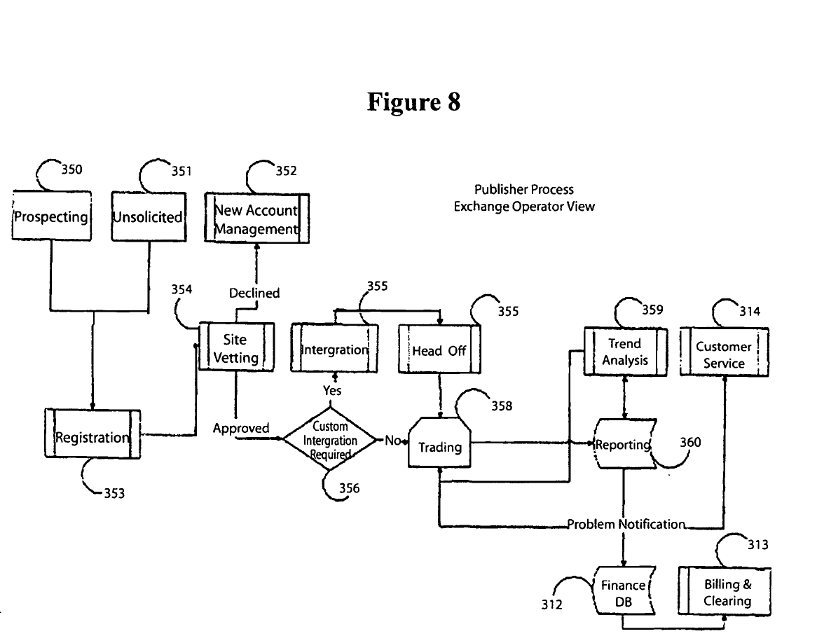

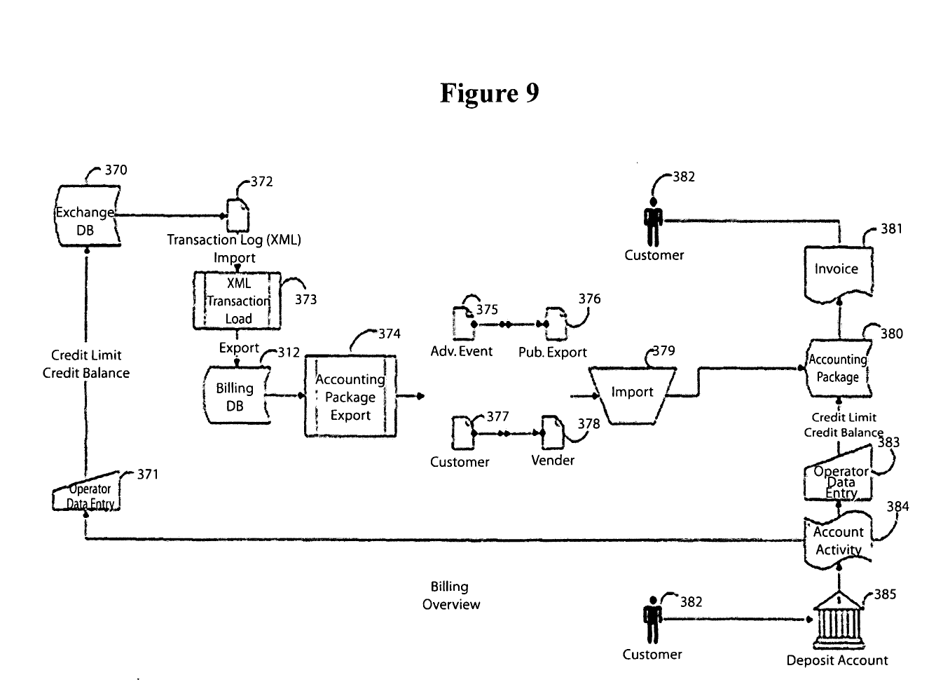

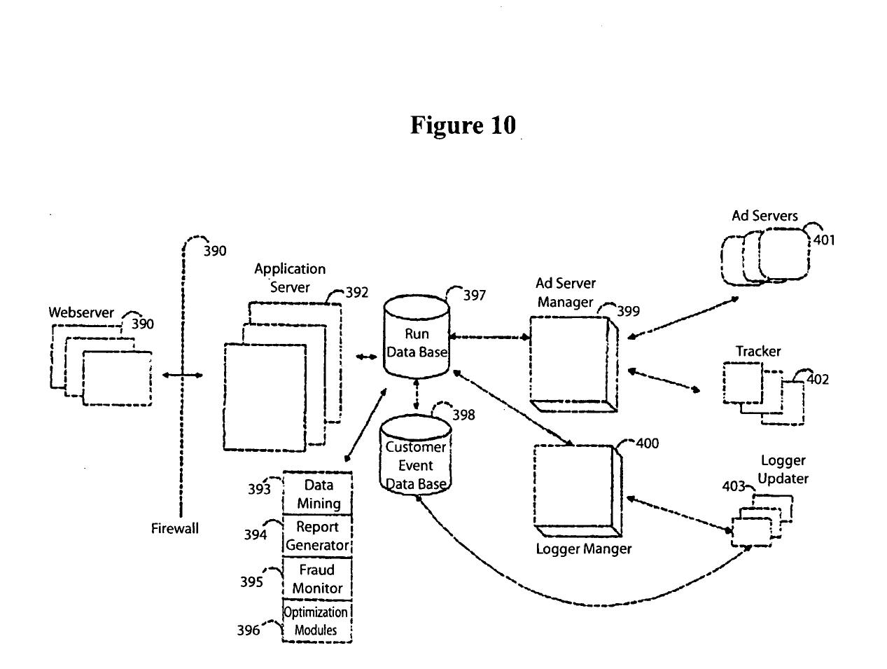

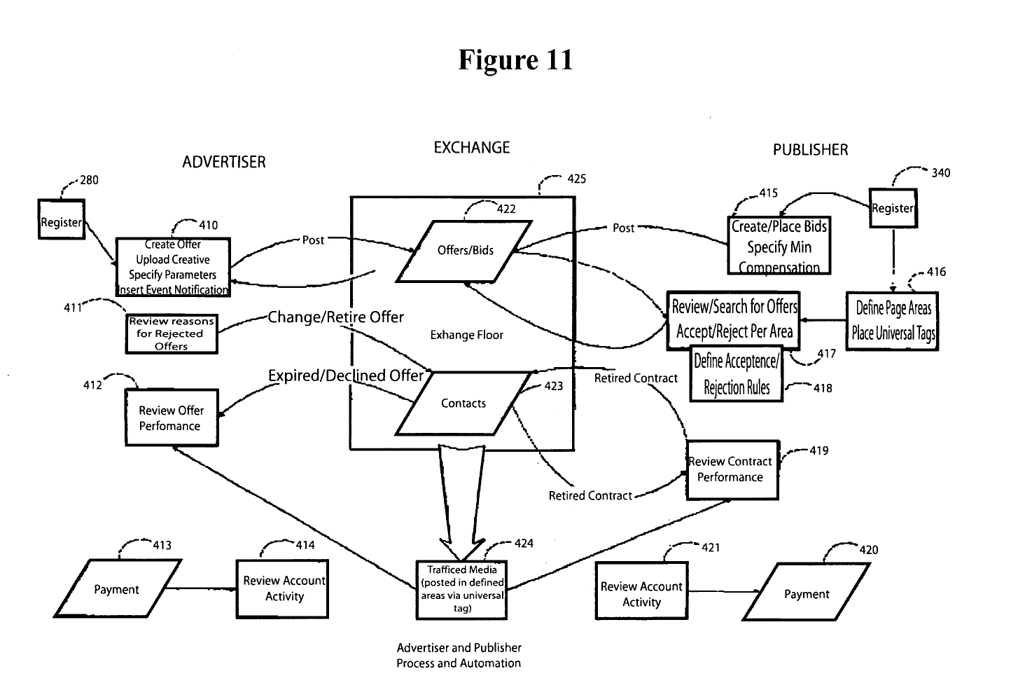

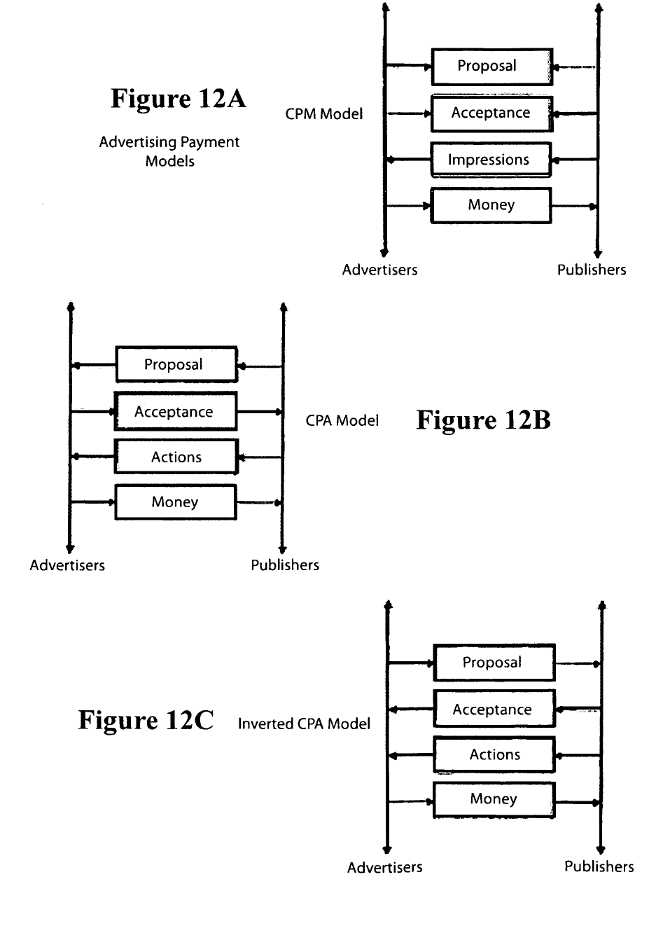

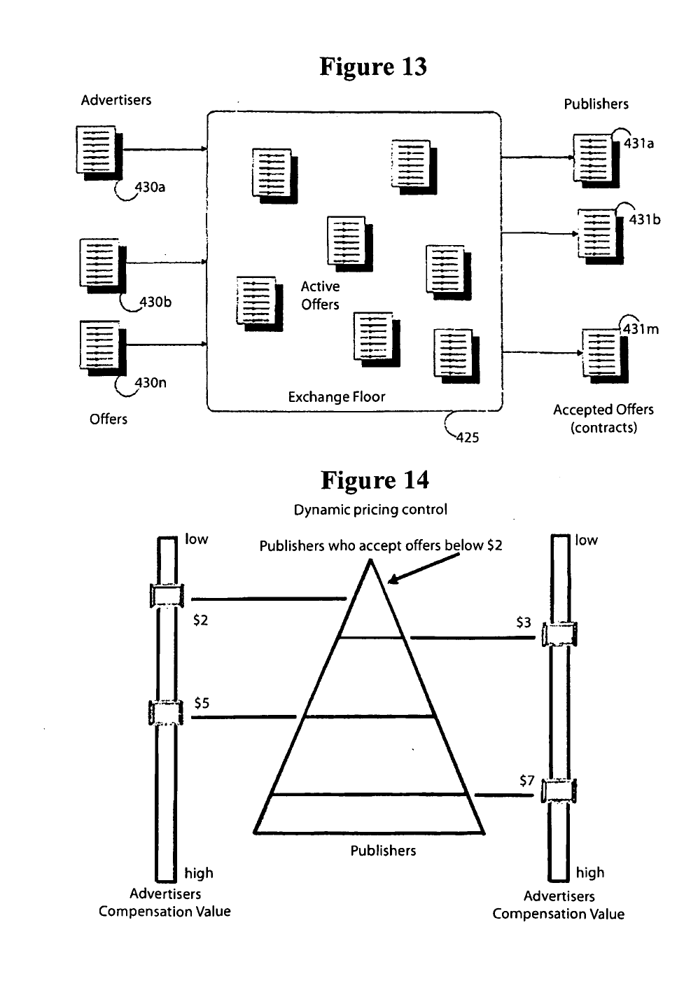

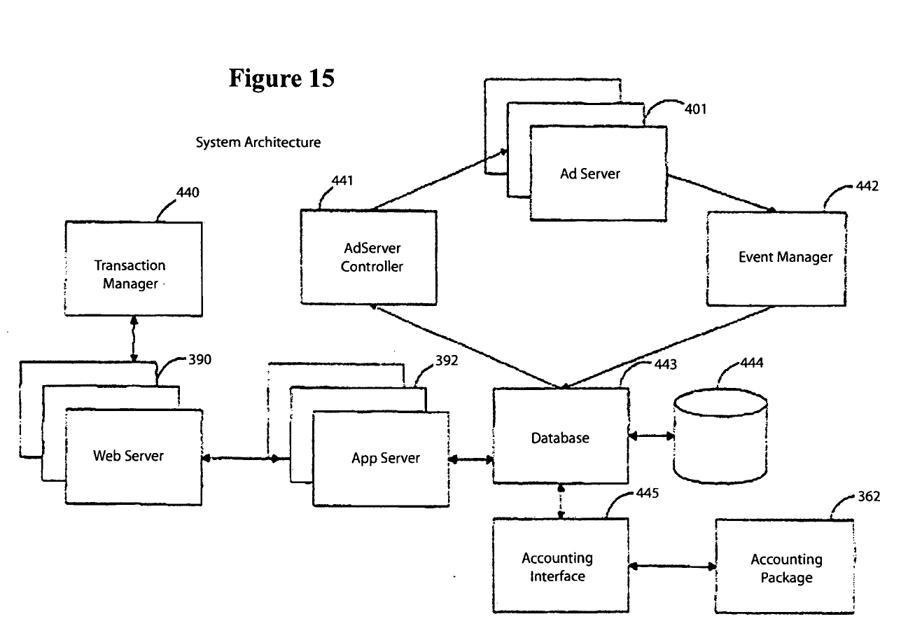

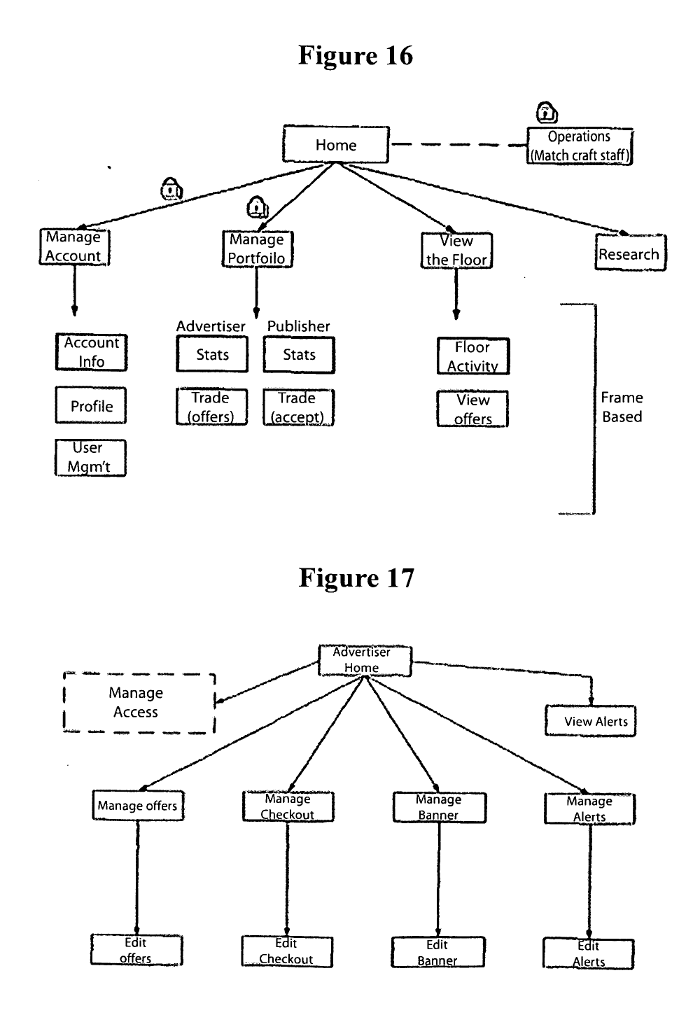

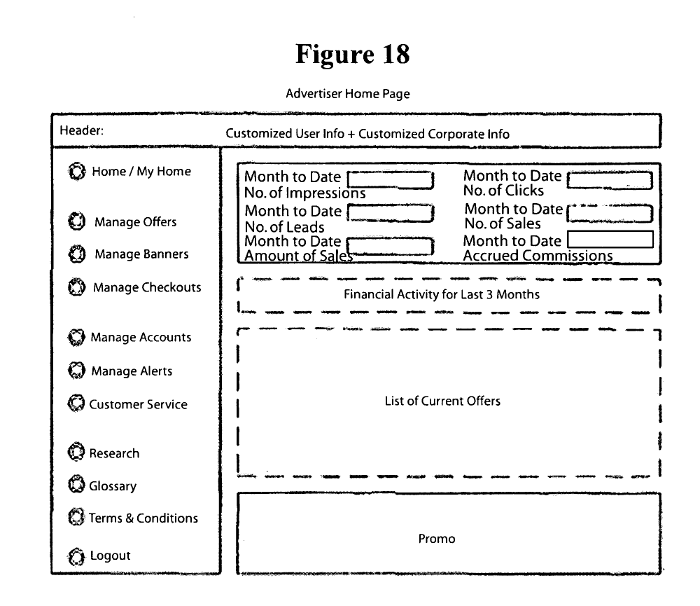

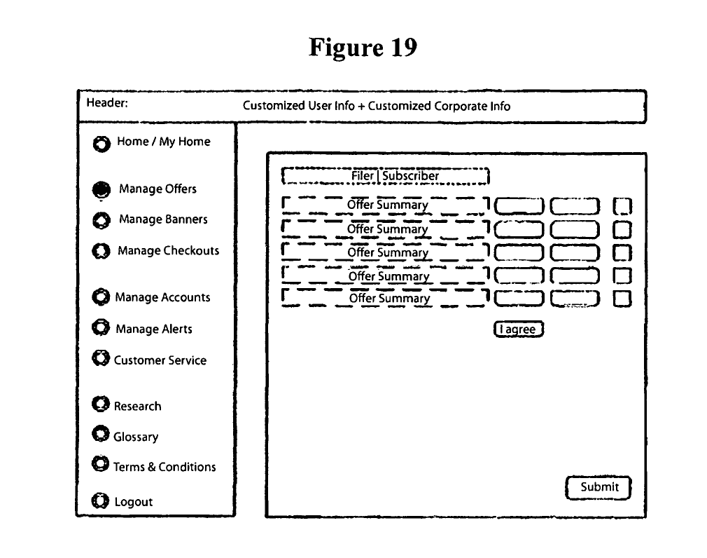

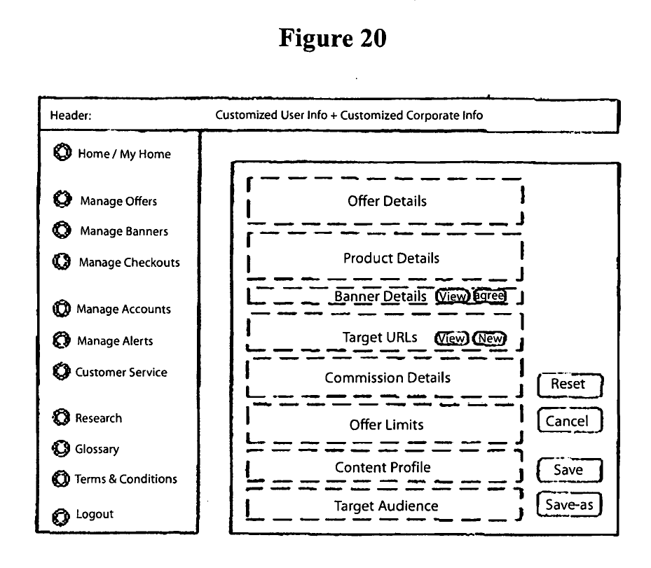

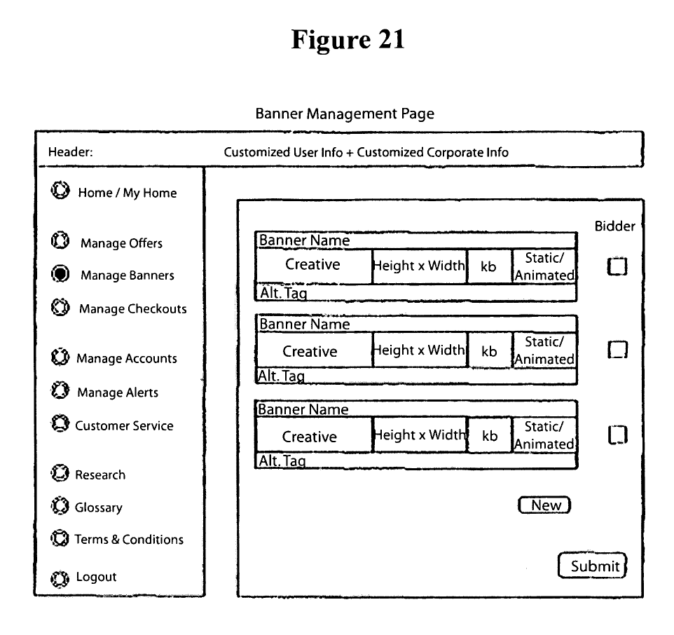

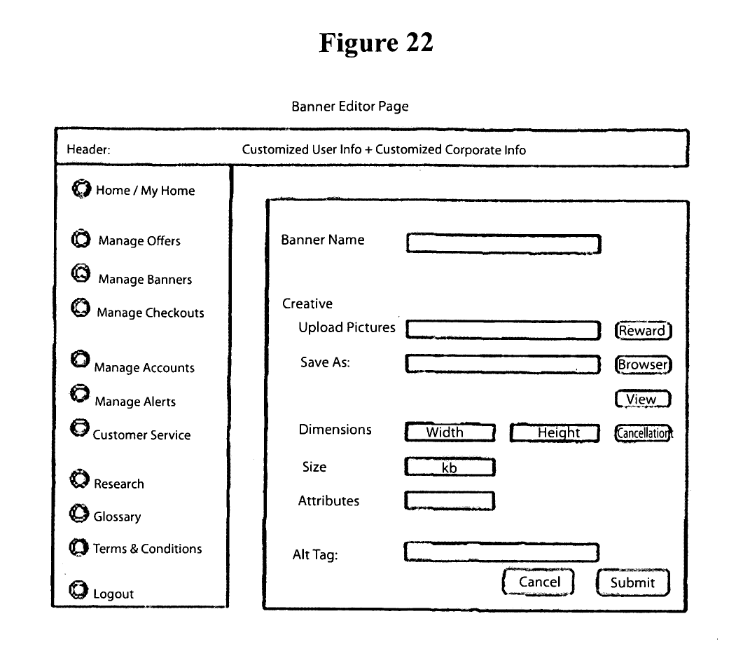

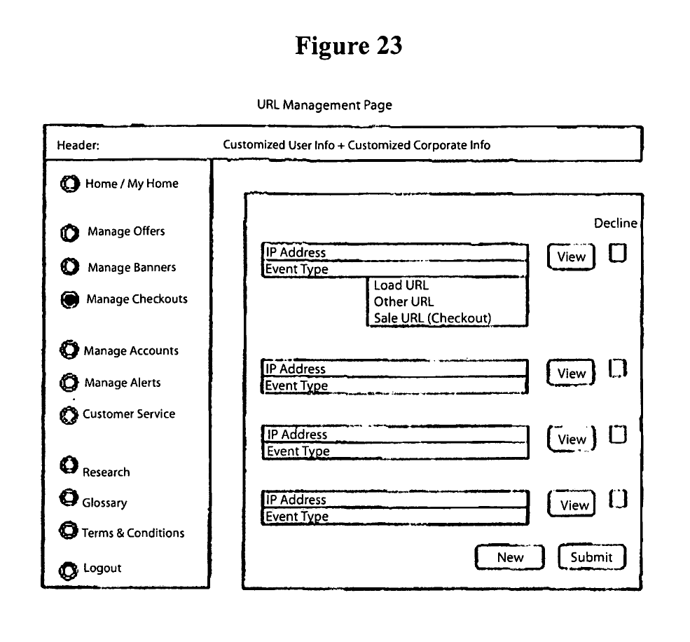

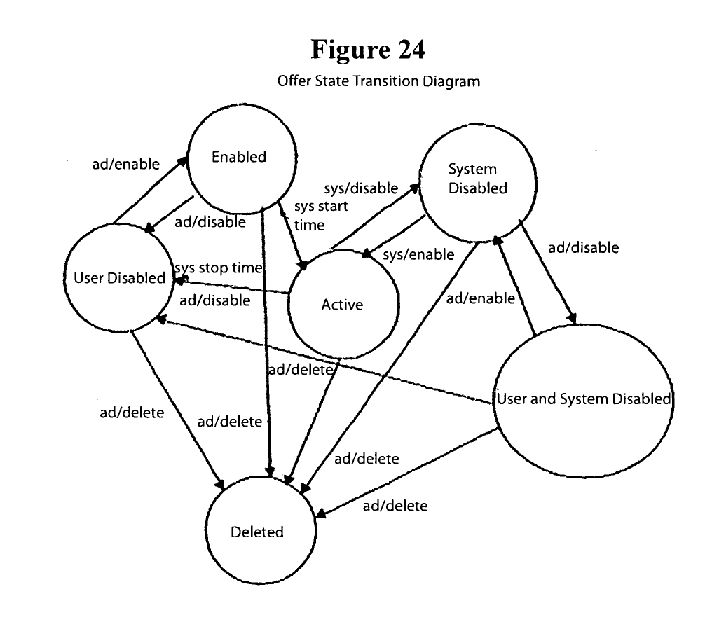

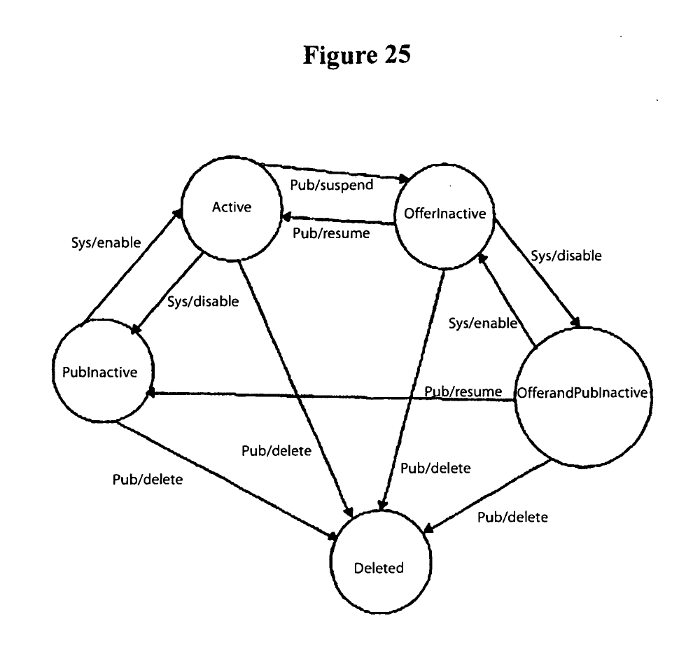

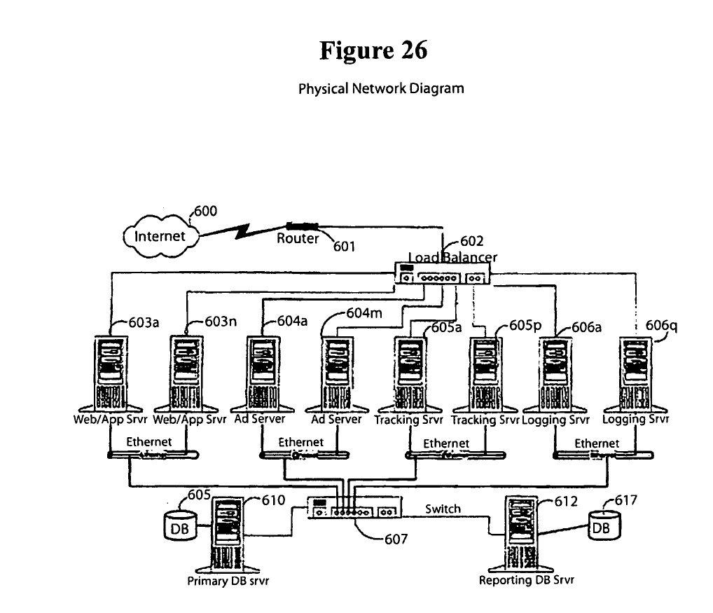

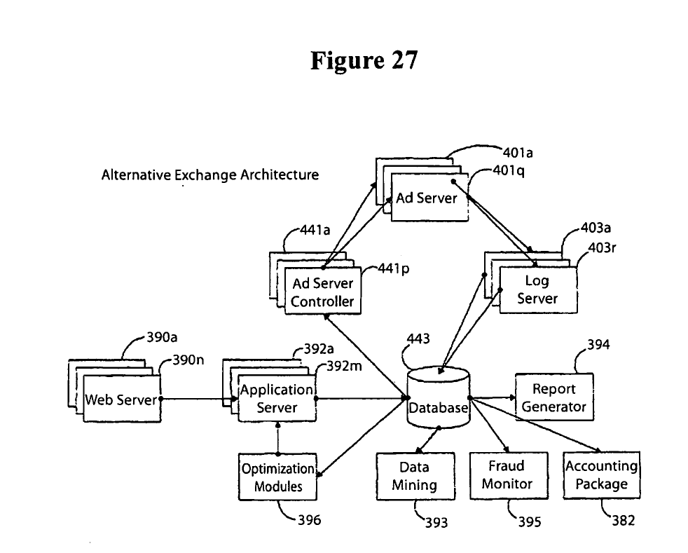

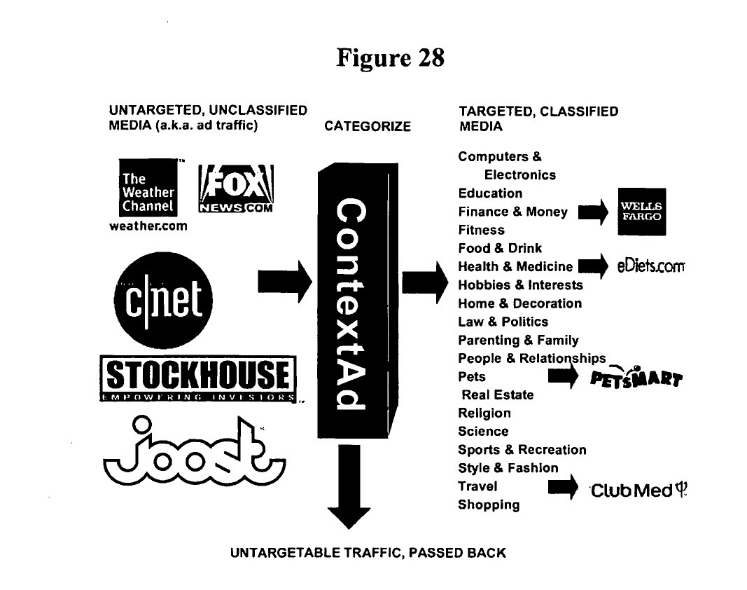

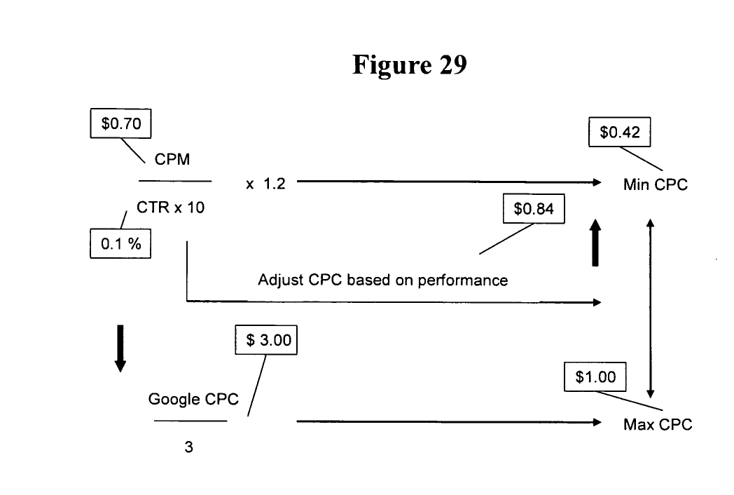

Like reference numerals refer to corresponding parts throughout the several views of the drawings.

### DETAILED DESCRIPTION OF THE ILLUSTRATIVE EMBODIMENTS

By way of overview and introduction, presented and described are embodiments of a method and system that brings Advertisers and Publishers together to buy, sell, and manage ad media; as well as manage categorization and delivery of ad requests according to specifications provided by the owning parties.

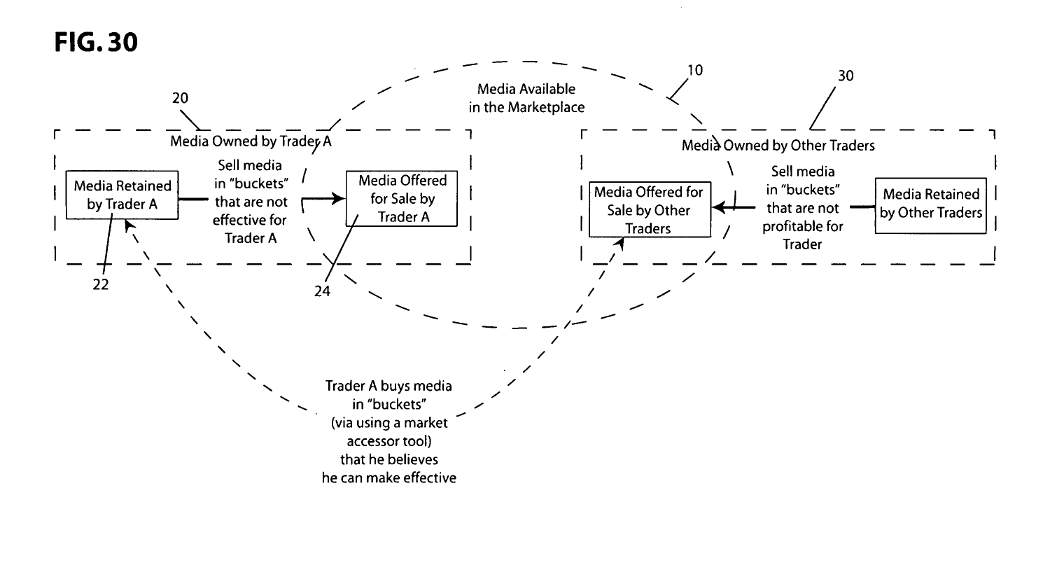

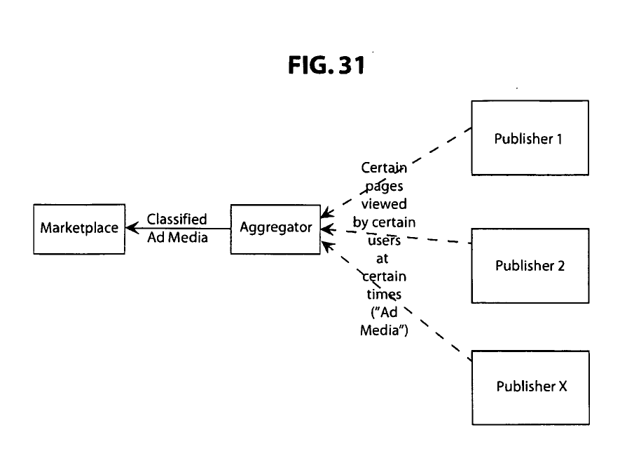

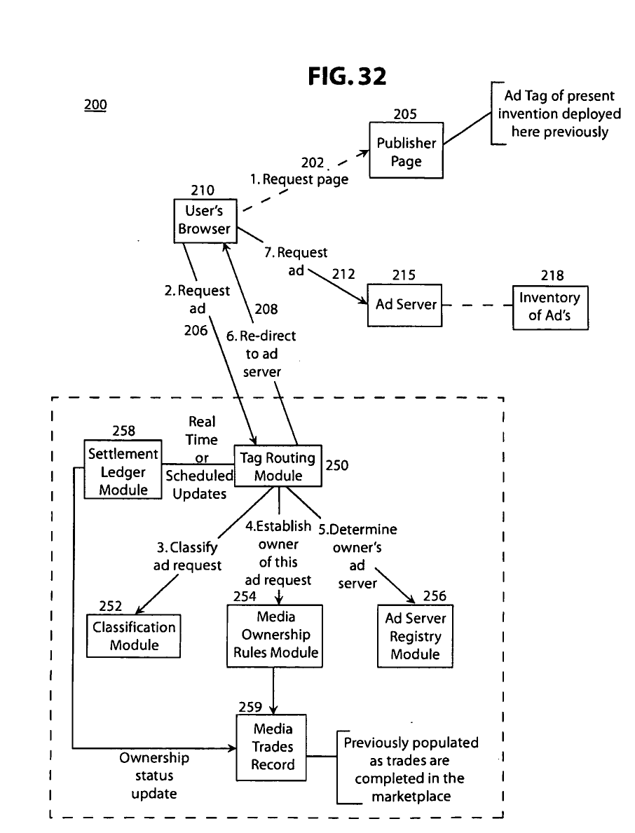

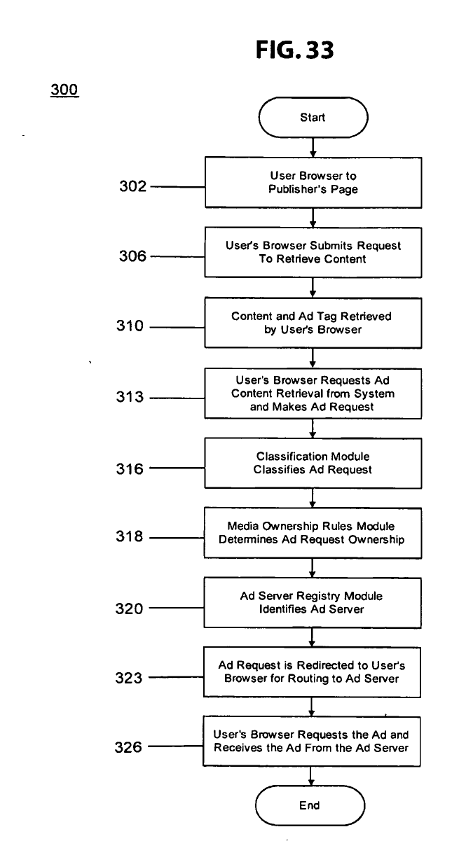

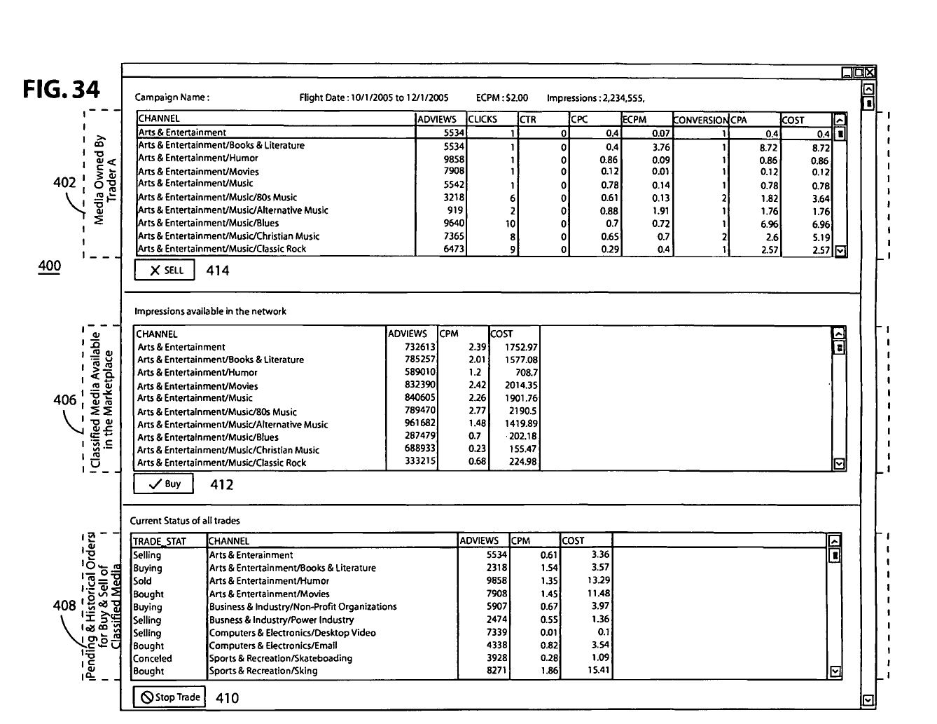

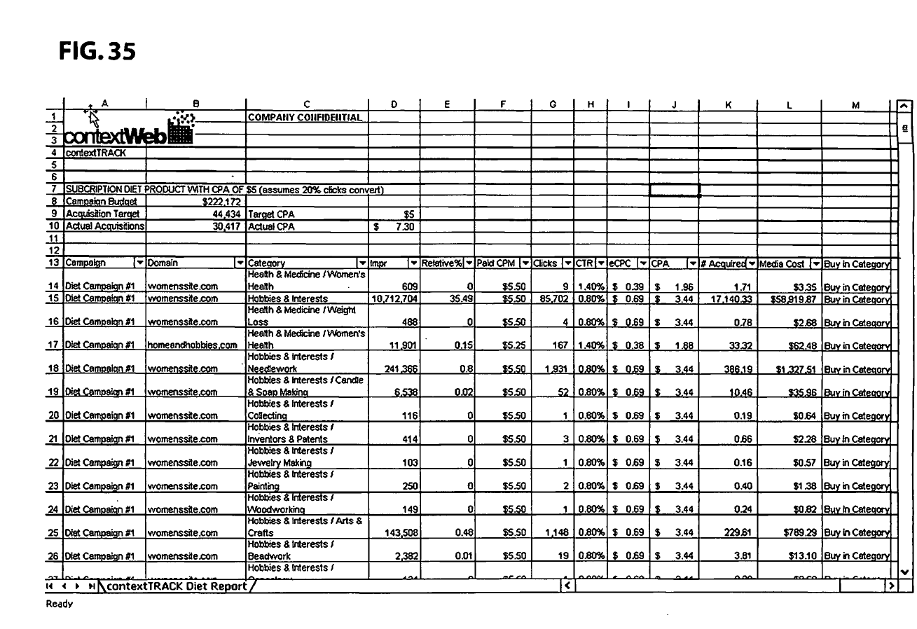

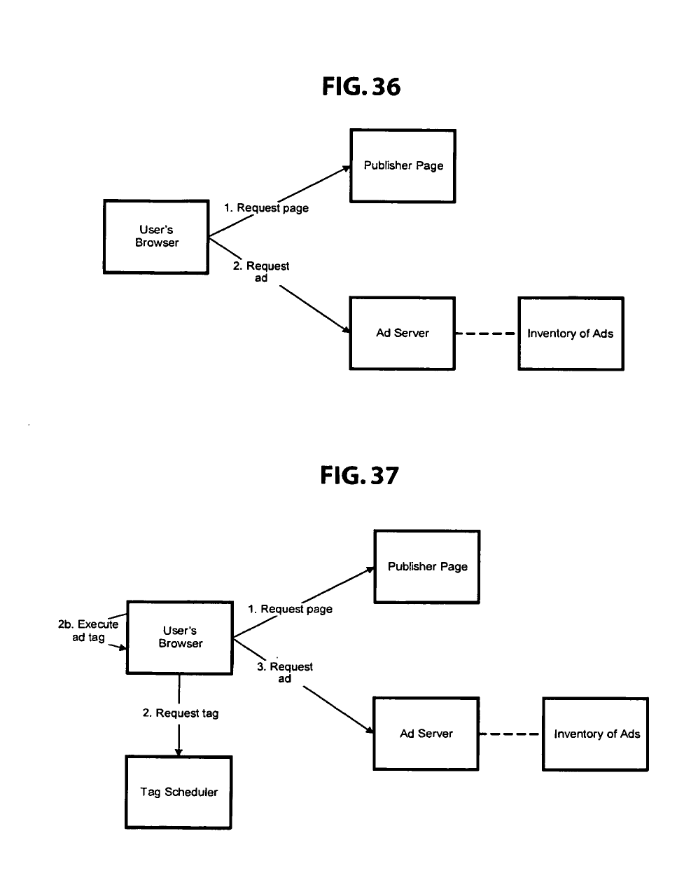

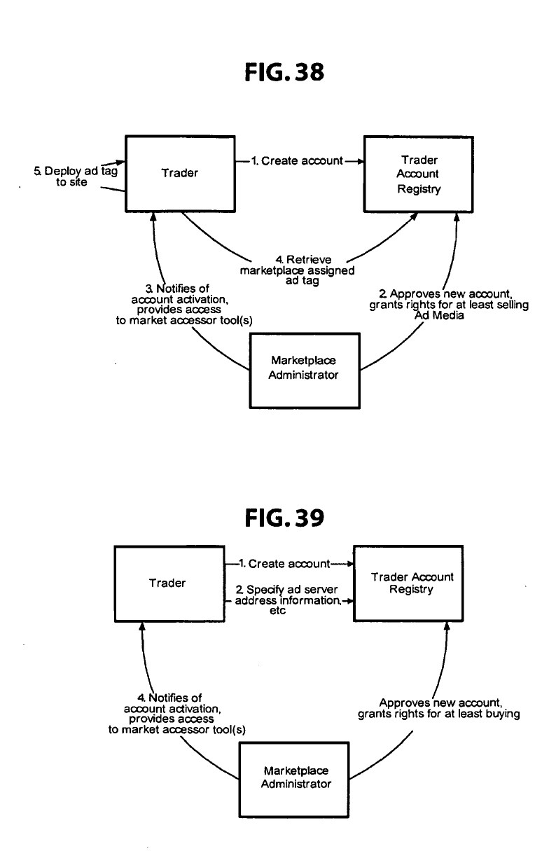

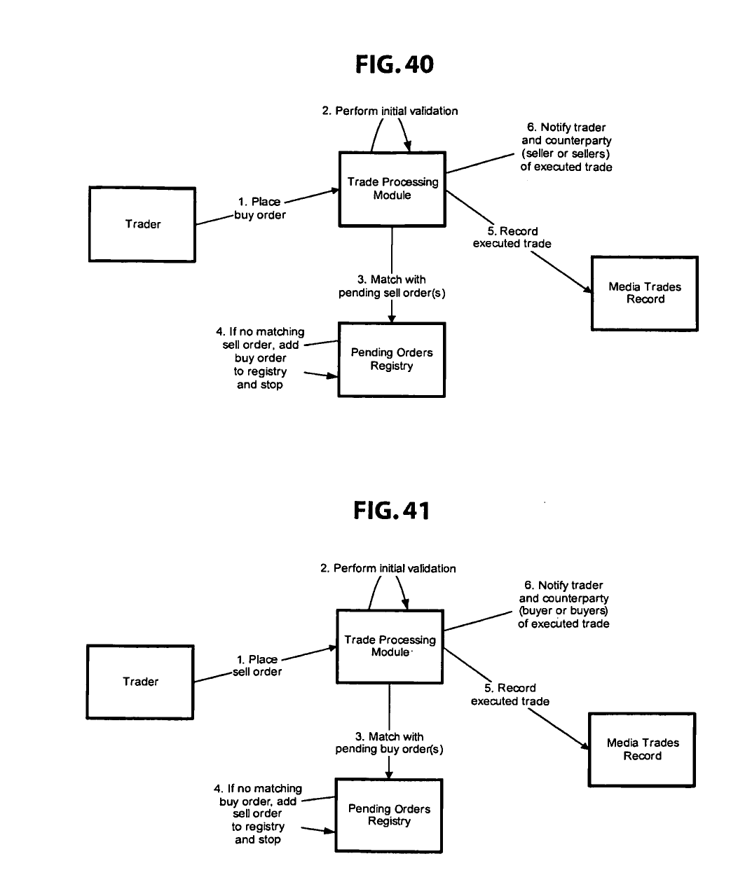

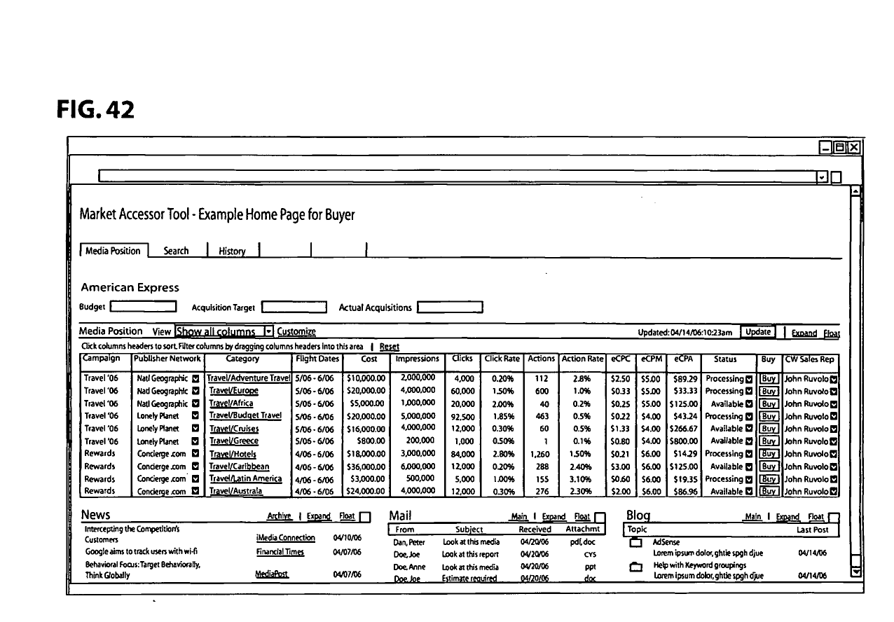

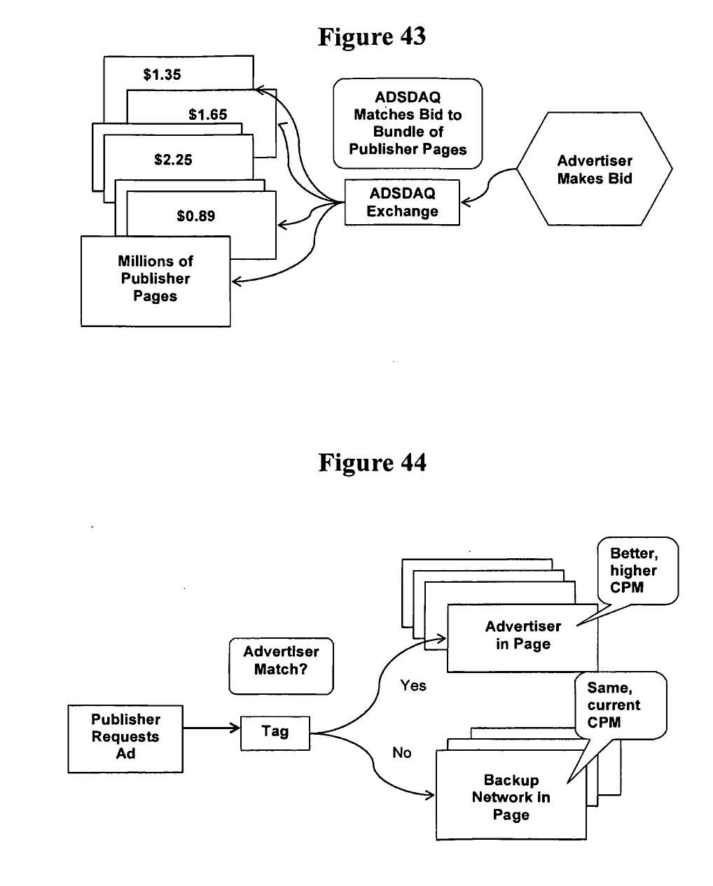

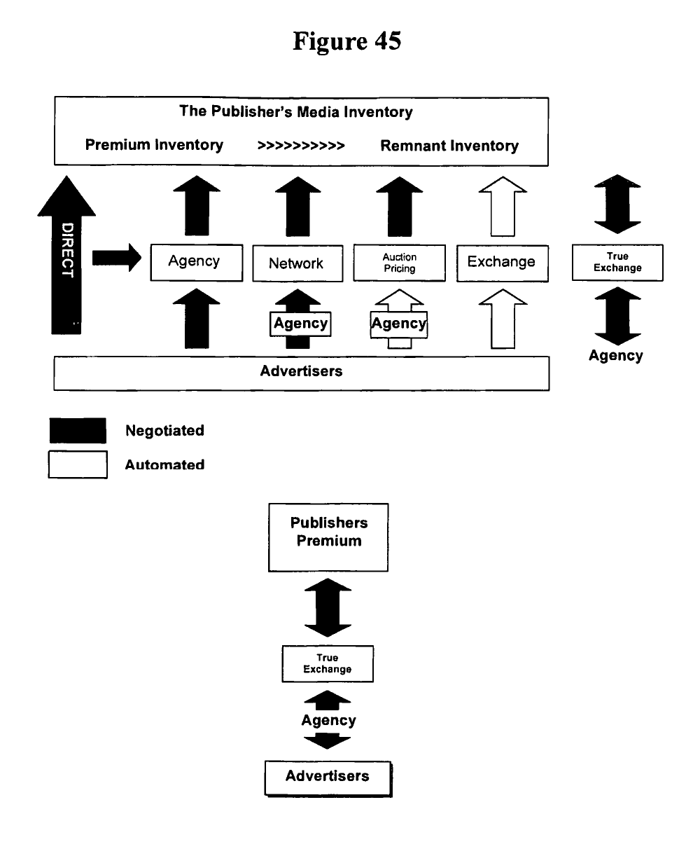

A system, FIG. 30, embodying the present invention provides a standardized exchange where Advertisers and Publishers can meet to buy and/or sell media according to free-market prices and a standard categorization approach. Publishers have advertisement spots to sell for which they choose their AskPrice™. Advertisers aim to match their ads to their desired audience's interests. The exchange receives an impression and categorizes page's content as well as checks which ad campaigns have an acceptable BidPrice™. The exchange checks each ad's performance for pages of this category in this site. Publisher's ad spots sold efficiently so each filled impression is paid guaranteed AskPrice™. Advertiser's ad shown to the most relevant audience at the right price. In summary, both the Advertiser and the Publisher get to name their price, the exchange applies categories to the ad media in real-time page-level categorization, effectively providing true control for publishers and advertisers through the new exchange model.

An online media exchange and method comprising:

an exchange system configured to provide a user interface to advertisers and publishers accessing the online media exchange;

a publisher to sell ad spots;

an advertiser with ad campaigns;

receiving from one or more advertisers data defining bids to purchase advertising media; receiving from one or more publishers data defining offers to sell advertising media;

matching bid to purchase of a contracting advertiser with an offer to sell of respective contracting publishers to form respective contracts;

serving advertising content including advertising media defined by the contract to consumers accessing websites of the respective publishers; and

passing back the untargetable or unclassifiable ad media when a match is not able to be made to one or more backup ad networks designated by the publisher.

The online media exchange can be a computer system comprising:

an internet server configured to provide a user interface to advertisers and publishers accessing the online media exchange;

one or more application servers configured to manage data objects associated with respective advertisers and publishers and further configured to manage online negotiations between advertisers and publishers regarding placement of advertiser ads on publisher websites;

a database in communication with the one or more application servers, the database storing data including the data objects;

and one or more ad servers in communication with the database, the one or more ad servers configured to serve data defining advertiser ads to publisher websites.

The online media exchange may optionally include one or more application servers configured to manage data objects associated with respective advertisers and publishers and further configured to manage online negotiations between advertisers and publishers regarding placement of advertiser ads on publisher websites. The online media exchange may also optionally include and one or more ad servers in communication with the database, the one or more ad servers configured to serve data defining advertiser ads to publisher websites.

Another novel aspect of the present invention is the ability to pass back the untargetable or unclassifiable ad media when a match is not able to be made. This ensures that the publisher always receive their asking price, never less than that amount. For instance, if no ads are available at the CPM asking price, then the exchange will send the ad impression to one or more backup ad networks designated by the publisher. Furthermore, there is compatibility with a publisher's existing advertising networks and thus no need for exclusivity. When an advertiser on the exchange cannot deliver the asking price, the exchange will serve ads from the publisher's other designated advertising networks. This always guarantees a better result than ad network alternatives because the publisher sets the asking price and thus set the price of their inventory. They will enjoy a 10-20% higher payout than ad networks are currently paying the publisher because the publisher gets control of their pricing. Furthermore, this feature provides better management of ad trafficking and smart decisions about when to serve the highest paying advertiser.

Beyond being a marketplace for buying and/or selling media and managing owned media, the system 200 also includes a delivery aspect. The exchange technology converts publisher impressions into standardized Contextual Tradable Units™ (CTUs) in real-time. Advertisers can purchase impressions from one or more of the exchange's 344 categories. Thus, the system brokers ad requests generated by media transacted on the marketplace platform by performing real-time categorization of each request. By brokering the request, the system identifies the media buyer who owns the ad request and associates the appropriate Ad Tag (i.e., the Ad Tag registered in the system to that media buyer). This association by the system results in the ad request being routed to the media buyer's desired Ad Server.

Different embodiments interrelate the following elements:
1. A set of publishers, each representing a property, or network of properties, that contains pages where ads may be shown.
2. A set of advertisers, each owning one or more advertisements that the advertiser wishes to have displayed to end users under certain defined conditions.
3. A media marketplace, or exchange, where parties may buy and/or sell media with each other according to free market prices, using standardized, or customized, tools. The exchange taking place on the Internet.
4. An inventory of ad media, comprising a projected quantity of ad requests to be filled as users request and view publisher pages, where the pages contain space available for advertising
5. A tag routing module, which is able to receive, classify (via the classification module) and route ad requests in real time to the ad server(s) specified by media owners.

Other embodiments and implementations of the market accesor tool, consistent with the purpose of empowering users (e.g., traders and other actors in the marketplace) to transact business in the marketplace and to carry out other management and analysis activities related to the marketplace, are within the scope and spirit of the invention. Activities related to the herein described online exchange include, but are not limited to:
providing data about responses to the offer from publishers.
receiving modifications to the offer or modified offers.
receiving ad preference data from a publisher for ads to be hosted by the publisher.
storing data about the offers, the bids and matched offers and bids for subsequent retrieval.
storing data about event types defined for received offers and bids, storing data about conversion ratios for received offers and bids, storing data about event counts for received offers and bids.
detecting and receiving one of revised offer information modifying the data received defining an offer to sell; and revised offer information modifying the data received defining a bid to purchase.
detecting and receiving data defining offers to sell comprises receiving from the one or more advertisers information about one or more of creative, a product offer, a flight time, a maximum pay-out amount, a compensation amount, a per click payment amount, a per download payment amount, and a publisher content description.
Detecting and receiving data defining bids to purchase comprises receiving from the one or more publishers information about one or more of creative properties, a minimum acceptable incentive level, a minimum effective cost per thousand impressions (CPM), and minimum expected flight duration.
matching an offer to sell with one or more bids to purchase comprises: filtering the offer to sell against requirements of the bids of the one or more publishers.
reporting to advertisers and publishers data about received offers and received bids.
determining an effective cost per thousand impressions (ECPM) for at least one of advertiser offers and publisher bids.
determining ECPM as a ratio of value of the advertising media to number of impressions of the advertising content served
matching the offer to sell with the one or more bids to purchase by comparing ECPM for the offer to sell with ECPM for the one or more bids.
determining past ECPM based on observed activity.
determining ECPM based on stored data defining compensation levels for matched offers.
determining future ECPM based on observed one of historical event counts and conversion ratios, and current incentive levels.
determining future ECPM as a ratio of a predicted value and number of impressions delivered.
determining predicted value as a sum of products of current incentive levels and historical event counts over all event types.

Thus, while there have been shown, described, and pointed out fundamental novel features of the invention as applied to several embodiments, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

We claim:

1. An online media exchange comprising:
an exchange system configured to provide a user interface to advertisers and publishers accessing the online media exchange;
a publisher to sell ad spots;
an advertiser with ad campaigns;
receiving from one or more advertisers data defining bids to purchase advertising media;
receiving from one or more publishers data defining offers to sell advertising media;
matching bid to purchase of a contracting advertiser with an offer to sell of respective contracting publishers to form respective contracts;
serving advertising content including advertising media defined by the contract to consumers accessing websites of the respective publishers; and
passing back the untargetable or unclassifiable ad media when a match is not able to be made to one or more backup ad networks designated by the publisher.

2. An online media exchange of claim 1 further comprising a computer system, wherein the computer system is defined as:
an internet server configured to provide a user interface to advertisers and publishers accessing the online media exchange;
one or more application servers configured to manage data objects associated with respective advertisers and publishers and further configured to manage online negotiations between advertisers and publishers regarding placement of advertiser ads on publisher websites;
a database in communication with the one or more application servers, the database storing data including the data objects;
and one or more ad servers in communication with the database, the one or more ad servers configured to serve data defining advertiser ads to publisher websites.

3. An online media exchange of claim 2 further comprising: an ad server controller in communication with the database and the one or more ad servers and configured to convey advertising data from the database to the one or more ad servers.

4. An online media exchange of claim 2 wherein the one or more ad servers are configured to receive an online request from a consumer, the online request specifying a contracting publisher and an ad; record data regarding the online request; and redirect the consumer to an advertiser website based on data of the request, the advertiser website being associated with a contracting advertiser.

5. An online media exchange of claim 3 wherein the one or more ad servers are further configured to:
receive a subsequent request from the consumer, subsequent request including data specifying an action performed by the consumer at the advertiser website;
record data regarding the action, the data being recorded in association with contract data linking the contracting advertiser and the contracting publisher.

6. An online media exchange of claim 2 further comprising an accounting package in communication with the database, the accounting package configured to manage billing among the advertisers and the publishers.

7. An online media exchange of claim 2 wherein the web server is configured to receive an offer from an advertiser.

8. An online media exchange of claim 7 wherein the web server is configured to detect in the offer one or more of creative, a product offer, a flight time, a maximum pay-out amount, a compensation amount, a per click payment amount, a per download payment amount, and a publisher content description.

9. An online media exchange of claim 7 wherein the web server is configured to provide data about responses to the offer from publishers.

10. An online media exchange of claim 7 wherein the web server is configured to receive modifications to the offer or modified offers.

11. An online media exchange of claim 2 wherein the web server is configured to receive ad preference data from a publisher for ads to be hosted by the publisher.

12. An online media exchange of claim 11 wherein the web server is configured to detect in the ad preference data one or more of creative properties, a minimum acceptable incentive level, a minimum effective cost per thousand impressions (ECPM), and minimum expected flight duration.

13. An online media exchange of claim 2 wherein the one or more application servers are configured to match advertiser offers to publishers.

14. An online media exchange of claim 2 wherein the one or more application servers are further configured to match the advertiser offers to publishers based on a calculated effective cost per thousand impressions.

15. An online media exchange of claim 2 wherein the one or more application servers are further configured to filter the advertiser offers according to publisher-specified filtering criteria.

16. An online media exchange of claim 2 wherein the one or more application servers are configured to monitor and log trade transactions between advertisers and publishers.

17. An online media exchange of claim 2 wherein the one or more application servers are configured to monitor start conditions and termination conditions of trade transactions between advertisers and publishers.

18. An online media exchange of claim 2 wherein the one or more application servers are configured to determine an effective cost per thousand impressions for trade transactions between advertisers and publishers.

19. An online media exchange comprising a computer system with:
means for storing data defining an offer to sell advertising media, the data including data defining a consumer action as a variable input for calculating compensation payable to a publisher for purchase of the advertising media;
means for storing data defining an offer to purchase advertising media, the data including data defining a consumer action as a variable input for calculating compensation payable to an advertiser for purchase of the advertising media;
means for comparing the data defining an offer to sell advertising media and the data defining an offer to purchase advertising media;
means for establishing a contract between an advertiser and a publisher based on the stored data defining an offer to sell advertising media and the stored data defining an offer to purchase advertising media;
and means for tracking commissions owed, billed and received under the contract.

20. The online media exchange of claim 19 further comprising:
means for storing data defining advertising content to be presented in the advertising media;
and means for serving the data defining advertising content on the advertising media if the data defining an offer to sell advertising media meets terms of the data defining an offer to purchase advertising media.

21. The online media exchange of claim 18 further comprising: means for receiving from an advertiser the data defining an offer to sell advertising media; and means for receiving from a publisher the data defining an offer to purchase advertising media.

22. A method for operating an online media exchange, the method comprising:
an exchange system configured to provide a user interface to advertisers and publishers accessing the online media exchange;
a publisher to sell ad spots;
an advertiser with ad campaigns;
receiving from one or more advertisers data defining bids to purchase advertising media; receiving from one or more publishers data defining offers to sell advertising media;
matching bid to purchase of a contracting advertiser with an offer to sell of respective contracting publishers to form respective contracts;
serving advertising content including advertising media defined by the contract to consumers accessing websites of the respective publishers; and
passing back the untargetable or unclassifiable ad media when a match is not able to be made to one or more backup ad networks designated by the publisher.

23. A method for operating a computer system, the method comprising:
storing data defining an offer to sell advertising media, the data including data defining a consumer action as a variable input for calculating compensation payable to a publisher for purchase of the advertising media;
storing data defining an offer to purchase advertising media, the data including data defining a consumer action as a variable input for calculating compensation payable to an advertiser for purchase of the advertising media;
comparing the data defining an offer to sell advertising media and the data defining an offer to purchase advertising media;
and establishing a contract between an advertiser and a publisher based on the stored data defining an offer to sell advertising media and the stored data defining an offer to purchase advertising media.

24. The method of claim 22 further comprising: trafficking media in accordance with the contract.

25. The method of claim 22 wherein trafficking media comprises: serving banner advertisements created by the advertiser for publication by the publisher.

26. The method of claim 22 further comprising: establishing a commission based on the contract.

27. The method of claim 22 wherein establishing a commission comprises: establishing a commission based on a number of impressions of advertiser creative served.

28. The method of claim 26 wherein establishing a commission comprises: establishing a commission based on a number of click-throughs.

29. The method of claim 26 wherein establishing a commission comprises: establishing a commission based on a number of leads.

30. The method of claim 26 wherein establishing a commission comprises: establishing a commission based on a number of post-click-through actions of a consumer.

31. The method of claim 22 wherein establishing a commission comprises: establishing a flat rate commission.

32. The method of claim 24 wherein establishing a commission comprises: establishing a percentage rate commission.

33. The method of claim 24 wherein establishing a commission comprises: receiving data defining the commission from one of the advertiser and the publisher.

34. A method for operating an online media exchange comprising:
receiving from one or more advertisers data defining offers to sell advertising media;
receiving from one or more publishers data defining bids to purchase advertising media;
matching an offer to sell of a contracting advertiser with one or more bids to purchase of respective contracting publishers to form respective contracts;
and serving advertising content including advertising media defined by the contract to consumers accessing websites of the respective publishers.

35. The method of claim 34 further comprising: storing data about the offers, the bids and matched offers and bids for subsequent retrieval.

36. The method of claim 35 wherein storing data comprises at least one of: storing data about event types defined for received offers and bids, storing data about conversion ratios for received offers and bids, storing data about event counts for received offers and bids.

37. The method of claim 34 further comprising: receiving one of revised offer information modifying the data received defining an offer to sell; and revised offer information modifying the data received defining a bid to purchase.

38. The method of claim 34 wherein receiving data defining offers to sell comprises receiving from the one or more advertisers information about one or more of creative, a product offer, a flight time, a maximum pay-out amount, a compensation amount, a per click payment amount, a per download payment amount, and a publisher content description.

39. The method of claim 34 wherein receiving data defining bids to purchase comprises receiving from the one or more publishers information about one or more of creative properties, a minimum acceptable incentive level, a minimum effective cost per thousand impressions (CPM), and minimum expected flight duration.

40. The method of claim 34 wherein matching an offer to sell with one or more bids to purchase comprises: filtering the offer to sell against requirements of the bids of the one or more publishers.

41. The method of claim 34 further comprising: reporting to advertisers and publishers data about received offers and received bids.

42. The method of claim 34 further comprising: determining an effective cost per thousand impressions (ECPM) for at least one of advertiser offers and publisher bids.

43. The method of claim 42 wherein determining the ECPM comprises: determining ECPM as a ratio of value of the advertising media to number of impressions of the advertising content served

44. The method of claim 43 wherein matching the offer to sell with the one or more bids to purchase comprises comparing ECPM for the offer to sell with ECPM for the one or more bids.

45. The method of claim 43 wherein determining ECPM comprises: determining past ECPM based on observed activity.

46. The method of claim 45 wherein determining past ECPM comprises determining ECPM based on stored data defining compensation levels for matched offers.

47. The method of claim 42 wherein determining ECPM comprises: determining future ECPM based on observed one of historical event counts and conversion ratios, and current incentive levels.

48. The method of claim 42 wherein determining ECPM comprises: determining future ECPM as a ratio of a predicted value and number of impressions delivered.

49. The method of claim 48 further comprising: determining predicted value as a sum of products of current incentive levels and historical event counts over all event types.

50. A method for trading advertising media, the method comprising:
providing an exchange data structure accessible via a communications network;
storing in said data structure data defining an offer to sell advertising media, said data defining a selling compensation scheme which uses a consumer action as a variable input to calculate compensation payable to purchase said advertising media;
storing in said data structure data defining an offer to purchase advertising media, said data defining a purchasing compensation scheme which uses a consumer action as a variable input to calculate compensation payable to purchase said advertising media;
comparing said offer to sell and said offer to purchase, to identify whether said offer to purchase meets the terms of said offer to sell.

51. The method of claim 50, further comprising:
storing data defining advertising content to be presented in said advertising media; and
publishing said advertising content data on said advertising media if said offer to purchase meets the terms of said offer to sell.

52. The method of claim 51, further comprising: g. measuring said consumer action.

53. The method of claim 50, further comprising: e. calculating the effective cost per thousand for said offer to purchase or said offer to sell, and outputting said effective cost per thousand.

54. The method of claim 50, wherein said offer to purchase is revocable at will.

55. A method for publishing information on the current market value of media, the method comprising:
providing an exchange data structure accessible via a communications network;
storing in said data structure data defining an offer to sell advertising media, said data defining a selling compensation scheme which uses a consumer action as a variable input to calculate compensation payable to purchase said advertising media;
storing in said data structure data defining an offer to purchase advertising media, said data defining a purchasing compensation scheme which uses a consumer action as a variable input to calculate compensation payable to purchase said advertising media;
publishing said data defining an offer to purchase or said data defining an offer to sell.

56. A system for trading advertising media, comprising:
an exchange data structure accessible via a communications network;
stored in said data structure, data defining an offer to sell advertising media, said data defining a selling compensation scheme which uses a consumer action as a variable input to calculate compensation payable to purchase said advertising media;
stored in said data structure, data defining an offer to purchase advertising media, said data defining a purchasing compensation scheme which uses a consumer action as a variable input to calculate compensation payable to purchase said advertising media;
means to compare said offer to sell and said offer to purchase, to identify whether said offer to purchase meets the terms of said offer to sell.

57. The system of claim 56, further comprising:
stored data defining advertising content to be presented in said advertising media; and
means for publishing said advertising content data on said advertising media if said offer to purchase meets the terms of said offer to sell.

58. The system of claim 57, further comprising: a means for measuring said consumer action.

59. The system of claim 57, further comprising: a calculator for calculating the effective cost per thousand for said offer to purchase or said offer to sell, and an output for outputting said effective cost per thousand.

60. The system of claim 56, wherein said offer to purchase is revocable at will.

61. A system for publishing information on the current market value of media, comprising:
an exchange data structure accessible via a communications network;
stored in said data structure, data defining an offer to sell advertising media, said data defining a selling compensation scheme which uses a consumer action as a variable input to calculate compensation payable to purchase said advertising media;
stored in said data structure, data defining an offer to purchase advertising media, said data defining a purchasing compensation scheme which uses a consumer action as a variable input to calculate compensation payable to purchase said advertising media;
publishing means for publishing said data defining an offer to purchase or said data defining an offer to sell.
